(19) United States
(12) Patent Application Publication
(10) Pub. No.: US 2012/0127214 A1
(43) Pub. Date: May 24, 2012

(54) LIGHT EMITTING DIODE DRIVING CIRCUIT, AND DISPLAY DEVICE HAVING THE SAME

(75) Inventors: Hee-Seok HAN, Hwaseong-si (KR); Jong-Seon Kim, Seongnam-si (KR)

(73) Assignee: Samsung Electronics Co., Ltd, Suwon-si (KR)

(21) Appl. No.: 13/241,737

(22) Filed: Sep. 23, 2011

(30) Foreign Application Priority Data
Nov. 18, 2010 (KR) 2010-0115081

(51) Int. Cl. G09G 3/14; H05B 37/02; G09G 5/10

(52) U.S. Cl. 345/690; 315/186; 315/122; 345/46

(57) ABSTRACT

A light-emitting-diode (LED) driving circuit and a display device include a current driving circuit, a level detector, a comparing circuit, a digital control circuit, and a power supply circuit. The level detector detects a minimum detection voltage signal having a minimum voltage level among voltage signals of first terminals of respective LED strings. The comparing circuit generates a first comparison output signal and a second comparison output signal based on a headroom-control reference voltage and the minimum detection voltage signal. The digital control circuit adjusts a duty ratio of a gate control signal in a digital mode based on the first comparison output signal, the second comparison output signal and a control clock signal. Therefore, the LED driving circuit has a small area in a semiconductor integrated circuit.

### CROSS-REFERENCE TO RELATED APPLICATIONS

This application claims priority under 35 U.S.C. §119 from Korean Patent Application No. 10-2010-0115081, filed on Nov. 18, 2010 in the Korean Intellectual Property Office, the disclosure of which is hereby incorporated by reference in its entirety.

### BACKGROUND

1. Field of the General Inventive Concept

Example embodiments relate to a light-emitting-diode (LED) driving circuit and a display device including the driving circuit.

2. Description of the Related Art

Recently, research on various types of light emitting technology is in progress due to the market demand for eco-friendly and low-power products.

Display devices now in use include plasma-display panels (PDPs), liquid-crystal displays (LCDs) and light-emitting-diode (LED) display devices, etc. The LED display device is a self-emitting device that emits light in response to a voltage applied between two terminals, and has attracted attention as next generation technology because of merits of stability, low heating value and low power consumption. The LED display devices are used not only as lamp devices but also as back-light units of LCD devices.

### SUMMARY

Embodiments of the general inventive concept provide a light-emitting-diode (LED) driving circuit that occupies a small area in a semiconductor integrated circuit.

Additional features and utilities of the present general inventive concept will be set forth in part in the description which follows and, in part, will be obvious from the description, or may be learned by practice of the general inventive concept.

Embodiments of the general inventive concept also provide an LED system including the LED driving circuit.

Embodiments of the general inventive concept also provide a display device including the LED driving circuit.

Embodiments of the general inventive concept also provide a method of driving an LED occupying a small area in a semiconductor integrated circuit.

The technical objectives of the general inventive concept are not limited to the above disclosure, other objectives may become apparent to those of ordinary skill in the art based on the following descriptions.

Embodiments of the present general inventive concept may be achieved by providing an LED driving circuit including a current driving circuit, a level detector, a comparing circuit, a digital control circuit, and a power supply circuit.

The current driving circuit may control current signals flowing through LED strings. The level detector may detect a minimum detection voltage signal having a minimum voltage level among voltage signals of first terminals of the respective LED strings. The comparing circuit may generate a first comparison output signal and a second comparison output signal based on a headroom-control reference voltage and the minimum detection voltage signal. The digital control circuit may adjust a duty ratio of a gate control signal in a digital mode based on the first comparison output signal, the second comparison output signal and a control clock signal. The power supply circuit may generate an LED driving voltage in response to the gate control signal.

In some embodiments, the comparing circuit may generate a first reference voltage and a second reference voltage having a lower voltage level than the first reference voltage based on the headroom-control reference voltage, and may compare the minimum detection voltage signal with the first reference voltage and the second reference voltage to generate the first comparison output signal and the second comparison output signal respectively.

In some embodiments, the first comparison output signal may be enabled when a magnitude of the minimum detection voltage signal is larger than a magnitude of the first reference voltage, and the second comparison output signal may be enabled when the magnitude of the minimum detection voltage signal is smaller than a magnitude of the second reference voltage.

In some embodiments, the digital control circuit may include a digital pulse-width-modulation (PWM) circuit and a logic circuit.

The digital PWM circuit may perform PWM to generate a set clock signal and a reset clock signal based on a duty control code. The logic circuit may change the duty control code according to logic states of the first comparison output signal and the second comparison output signal, and generate the gate control signal based on the set clock signal and the reset clock signal.

Embodiments of the present general inventive concept may be achieved by providing an LED system including an LED array and an LED driving circuit.

The LED array may emit light in response to an LED driving voltage. The LED driving circuit may detect a minimum detection voltage signal having a minimum voltage level among terminal voltage signals of respective LED strings, may generate comparison output signals based on a headroom-control reference voltage and the minimum detection voltage signal, may adjust a duty ratio of a gate control signal in a digital mode based on the comparison output signals and a control clock signal, and may generate the LED driving voltage in response to the gate control signal.

Embodiments of the present general inventive concept may be achieved by providing a display device including a display panel, a back-light driving circuit and a back-light unit.

The back-light driving circuit may detect a minimum detection voltage signal having a minimum voltage level among terminal voltage signals of respective LED strings, may generate comparison output signals based on a headroom-control reference voltage and the minimum detection voltage signal, may adjust a duty ratio of a gate control signal in a digital mode based on the comparison output signals and a control clock signal, and may generate an LED driving voltage in response to the gate control signal. The back-light unit may include the LED strings, operates in response to the LED driving voltage, and provides light to the display panel.

Embodiments of the present general inventive concept may be achieved by sensing voltage signals of first terminals of respective LED strings, detecting a minimum detection voltage signal having a minimum voltage level among voltage signals of the first terminals of the respective LED strings, generating a first reference voltage and a second reference voltage having a lower voltage level than the first reference voltage based on a headroom-control reference voltage, comparing the minimum detection voltage signal with the first reference voltage and the second reference voltage to generate a first comparison output signal and a second comparison output signal respectively, adjusting a duty ratio of a gate control signal in a digital mode based on the first comparison output signal, the second comparison output signal and a control clock signal, and generating an LED driving voltage in response to the gate control signal.

In some embodiments, adjusting the duty ratio of the gate control signal may include generating a duty control code that changes according to logic states of the first comparison output signal and the second comparison output signal, performing PWM based on the duty control code to generate a set clock signal and a reset clock signal, and generating the gate control signal based on the set clock signal and the reset clock signal.

Embodiments of the present general inventive concept may be achieved by providing a light-emitting diode (LED) driving circuit including a power supply circuit to supply a driving voltage to an LED array, the driving circuit including a level detector to detect a minimum voltage output from the LED array, a comparing circuit to output a plurality of comparison signals based on the detected minimum voltage and a headroom-control reference voltage (VRHR), and a digital control circuit to output a gate control signal to a gate of a NMOS power transistor of the power circuit such that a duty ratio of the gate control signal is changed based on a detection voltage of the NMOS power transistor and the driving voltage of the LED array.

The detection voltage of the NMOS power transistor may correspond to the current flowing through the NMOS power transistor.

The digital control circuit may include a digital pulse width modulation circuit and a logic circuit.

The digital control circuit may adjust the duty ratio of the gate control signal based on an over-voltage protection signal, a current-limit protection signal and a dimming signal.

The comparing circuit may generate a first reference voltage and a second reference voltage having a lower voltage level the first reference level based on the VRHR and compare the minimum voltage output from the LED array with the first reference voltage and the second reference voltage to generate the plurality of comparison signals output by the comparing circuit.

The LED driving circuit according to example embodiments may have a simple circuit structure, occupy a small area in a semiconductor integrated circuit, and be insensitive to noise because a gate driving signal is generated in a digital mode. Accordingly, a semiconductor device including the LED driving circuit may have low cost of production.

### BRIEF DESCRIPTION OF THE DRAWINGS

The foregoing and other features and utilities of the general inventive concepts will be apparent from the description of embodiments of the general inventive concepts, as illustrated in the accompanying drawings in which like reference characters refer to the same parts throughout the different views. The drawings are not necessarily to scale, emphasis instead being placed upon illustrating the principles of the general inventive concepts. In the drawings:

FIG. 1 is a block diagram illustrating a light-emitting-diode (LED) system in accordance with an embodiment of the general inventive concept;

FIG. 2 is a block diagram illustrating an LED driving circuit included in the LED system of FIG. 1, in accordance with an embodiment of the general inventive concept;

FIG. 3 is a circuit diagram illustrating a power supply circuit included in the LED driving circuit of FIG. 2, in accordance with an embodiment of the general inventive concept;

FIG. 4 is a circuit diagram illustrating a comparing circuit included in the LED driving circuit of FIG. 2, in accordance with an embodiment of the general inventive concept;

FIG. 5 is a block diagram illustrating a digital control circuit included in the LED driving circuit of FIG. 2, in accordance with an embodiment of the general inventive concept;

FIG. 6 is a block diagram illustrating an LED driving circuit included in the LED system of FIG. 1, in accordance with another embodiment of the general inventive concept;

FIG. 7 is a block diagram illustrating a digital control circuit included in the LED driving circuit of FIG. 6, in accordance with an embodiment of the general inventive concept;

FIG. 8 is a timing diagram illustrating an operation of the LED system of FIG. 1;

FIG. 9 is a block diagram illustrating an LED driving circuit included in the LED system of FIG. 1, in accordance with still another embodiment of the general inventive concept;

FIG. 10 is a block diagram illustrating an LED driving circuit included in the LED system of FIG. 1, in accordance with yet another embodiment of the general inventive concept;

FIG. 11 is a diagram illustrating reference voltages used in a comparing circuit included in the LED driving circuit of FIG. 10, in accordance with an embodiment of the general inventive concept;

FIG. 12 is a block diagram illustrating an example of a back-light system including an LED driving circuit in accordance with embodiments of the general inventive concept;

FIG. 13 is a block diagram illustrating another example of a back-light system including an LED driving circuit in accordance with embodiments of the general inventive concept;

FIG. 14 is a block diagram illustrating still another example of a back-light system including an LED driving circuit in accordance with embodiments of the general inventive concept;

FIG. 15 is a flowchart illustrating a method of driving an LED, in accordance with an embodiment of the general inventive concept;

FIG. 16 is a flowchart illustrating a method of adjusting the duty ratio of a gate control signal included in FIG. 15, in accordance with an embodiment of the general inventive concept;

FIG. 17 is a flowchart illustrating a method of generating a duty control code included in FIG. 16, in accordance with an embodiment of the general inventive concept;

FIG. 18 is a flowchart illustrating a method of adjusting the duty ratio of a gate control signal included in FIG. 15, in accordance with another embodiment of the general inventive concept;

FIG. 19 is a flowchart illustrating a method of adjusting the duty ratio of a gate control signal included in FIG. 15, in accordance with still another embodiment of the general inventive concept;

FIG. 20 is a flowchart illustrating a method of driving an LED, in accordance with another embodiment of the general inventive concept; and

FIG. 21 is a flowchart illustrating a method of driving an LED, in accordance with still another embodiment of the general inventive concept.

### DETAILED DESCRIPTION OF THE PREFERRED EMBODIMENTS

Various example embodiments will now be described more fully with reference to the accompanying drawings in which some example embodiments are illustrated. In the drawings, the thicknesses of layers and regions may be exaggerated for clarity.

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Detailed illustrative embodiments are disclosed herein. However, specific structural and functional details disclosed herein are merely representative for purposes of describing example embodiments. The present general inventive concept, however, may be embodied in many alternate forms and should not be construed as limited to only example embodiments set forth herein.

Accordingly, while example embodiments are capable of various modifications and alternative forms, embodiments thereof are illustrated by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the general inventive concept. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures illustrated in succession may in fact be executed substantially concurrently or may sometimes be executed in the reverse order, depending upon the functionality/acts involved.

In order to more specifically describe example embodiments, various features will be described in detail with reference to the attached drawings. However, the present general inventive concept is not limited to example embodiments described.

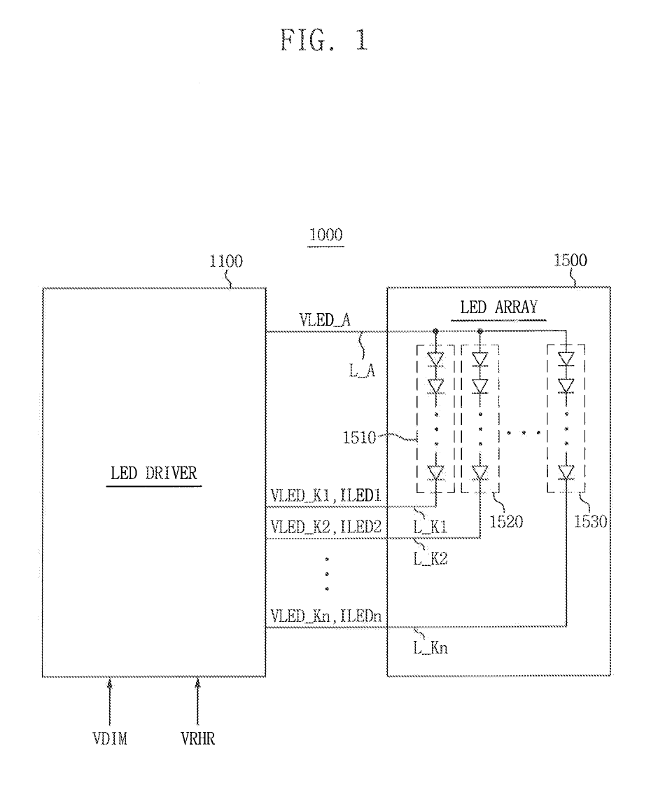

FIG. 1 is a block diagram illustrating a light-emitting-diode (LED) system 1000 in accordance with an embodiment of the general inventive concept.

Referring to FIG. 1, the LED system 1000 includes an LED driving circuit 1100 and an LED array 1500.

The LED array 1500 emits light in response to an LED driving voltage VLED_A. As will be described later, the LED driving circuit 1100 detects a minimum detection voltage signal having a minimum voltage level among terminal voltage signals of respective LED strings, generates comparison output signals based on a headroom-control reference voltage VRHR and the minimum detection voltage signal, adjusts a duty ratio of a gate control signal VG in a digital mode based on the comparison output signals and a control clock signal, and generates the LED driving voltage VLED_A in response to the gate control signal VG. Further, the LED driving circuit 1100 controls currents flowing through the LED strings 1510, 1520 and 1530 constituting the LED array 1500 based on a dimming signal VDIM. The headroom-control reference voltage VRHR may include information about the LED current. The information about the LED current may be a target LED current that can be controlled by users inside of a semiconductor integrated circuit including the LED driving circuit 1100 or outside of the semiconductor integrated circuit.

First terminals L_K1, L_K2, . . . , L_Kn of the LED strings 1510, 1520 and 1530 are connected to drains of respective power transistors constituting a current driving circuit included in the LED driving circuit 1100. In FIG. 1, voltages of the first terminals L_K1, L_K2, . . . , L_Kn are denoted by VLED_K1, VLED_K2, VLED_Kn, and currents flowing from the respective first terminals L_K1, L_K2, . . . , L_Kn to drains of the respective power transistors included in the LED driving circuit 1100 are denoted by ILED1, ILED2, . . . , ILEDn. Second terminals L_A of the respective LED strings 1510, 1520 and 1530 are electrically connected to each other.

The LED array 1500 may include the one or more LED strings 1510, 1520 and 1530, and each of the LED strings 1510, 1520 and 1530 may include one or more LEDs connected in series.

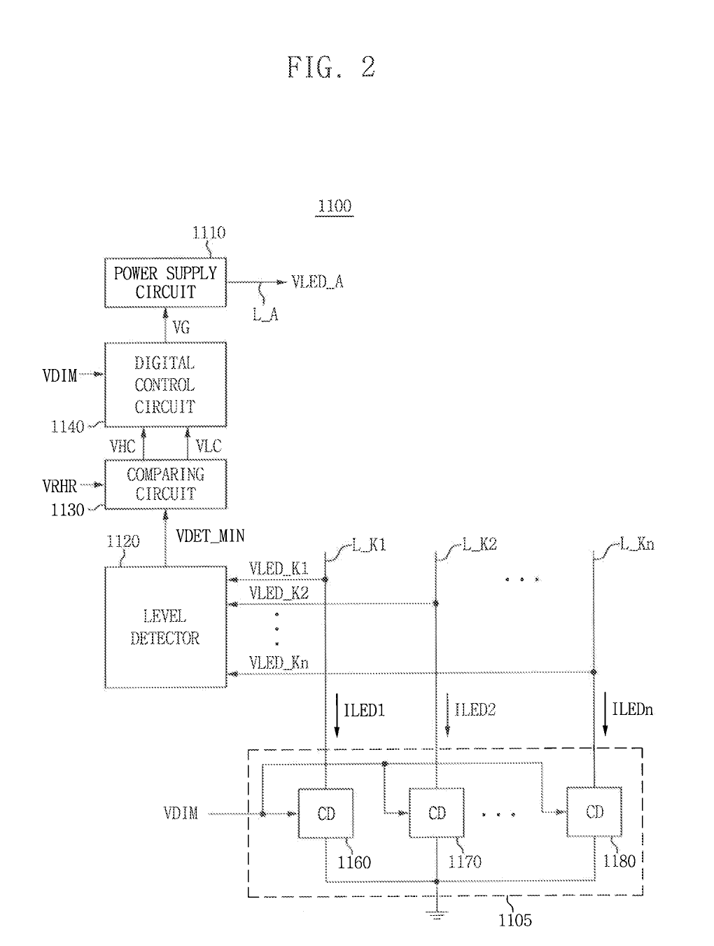

FIG. 2 is a block diagram illustrating an LED driving circuit 1100 included in the LED system 1000 of FIG. 1, in accordance with an embodiment of the general inventive concept.

Referring to FIG. 2, the LED driving circuit 1100 includes a power supply circuit 1110, a level detector 1120, a comparing circuit 1130, a digital control circuit 1140, and a current driving circuit 1105.

The current driving circuit 1105 includes current drivers 1160, 1170 and 1180, and controls current signals ILED1, ILED2, . . . , ILEDn flowing through LED strings 1510, 1520 and 1530 of FIG. 1 in response to the dimming signal VDIM. The level detector 1120 detects a minimum detection voltage signal VDET_MIN having a minimum voltage level among voltage signals of the first terminals L_K1, L_K2, . . . , L_Kn of the respective LED strings 1510, 1520 and 1530. The comparing circuit 1130 generates a first comparison output signal VHC and a second comparison output signal VLC based on a headroom-control reference voltage VRHR and the minimum detection voltage signal VDET_MIN. The digital control circuit 1140 adjusts a duty ratio of a gate control signal VG in a digital mode based on the first comparison output signal VHC, the second comparison output signal VLC and the dimming signal VDIM. The power supply circuit 1110 generates an LED driving voltage VLED_A in response to the gate control signal VG.

The level detector 1120 detects a minimum detection voltage signal VDET_MIN having a minimum voltage level among voltage signals of the first terminals L_K1, L_K2, . . . , L_Kn of the respective LED strings 1510, 1520 and 1530 that correspond to the current being driven through the LED strings 1510, 1520 and 1530.

The comparing circuit 1130 may generate a first reference voltage and a second reference voltage having a lower voltage level than the first reference voltage based on the headroom-control reference voltage VRHR, and may compare the minimum detection voltage signal VDET_MIN with the first reference voltage and the second reference voltage to generate the first comparison output signal VHC and the second comparison output signal VLC respectively.

The first comparison output signal VHC may be enabled when a magnitude of the minimum detection voltage signal VDET_MIN is larger than a magnitude of the first reference voltage, and the second comparison output signal VLC may be enabled when the magnitude of the minimum detection voltage signal VDET_MIN is smaller than a magnitude of the second reference voltage.

The first comparison output signal VHC may be disabled when the magnitude of the minimum detection voltage signal VDET_MIN is smaller than the magnitude of the first reference voltage, and the second comparison output signal VLC may be disabled when the magnitude of the minimum detection voltage signal VDET_MIN is larger than the magnitude of the second reference voltage.

FIG. 3 is a circuit diagram illustrating a power supply circuit 1110 included in the LED driving circuit 1100 of FIG. 2, in accordance with an embodiment of the general inventive concept.

The power supply circuit 1110 is a kind of direct current (DC)-DC converter, that is, a boost converter which receives a DC input voltage VIN to output a stable high DC voltage. Referring to FIG. 3, the power supply circuit 1110 includes an inductor L1, a first resistor RF, an n-channel metal-oxide semiconductor (NMOS) power transistor NMOS, a diode D1, a capacitor C1, a second resistor R1 and a third resistor R2.

The operation of the power supply circuit 1110 of FIG. 3 will be described below.

First, during the active period of a gate control signal VG, in which the gate control signal VG is in a logic high state, the NMOS power transistor NMOS is turned on and a current flows through the inductor L1, the NMOS power transistor NMOS and the first resistor RF. In this condition, the inductor L1 converts electric energy into the form of magnetic energy corresponding to the current and stores the magnetic energy. Therefore, the longer the active period of the gate control signal VG, the more magnetic energy is stored in the inductor L1.

Next, during the inactive period of the gate control signal VG, in which the gate control signal VG is in a logic low state, the NMOS power transistor NMOS is turned off, and the magnetic energy stored in the inductor L1 during the active period of the gate control signal VG is converted into the form of electric energy. That is, the inductor L1 generates a current by an electromotive force dependent on a magnitude of the stored magnetic energy, and the current flows through the diode D1, the second resistor R1 and the third resistor R2. The magnetic energy stored in the inductor L1 decreases at the same speed as the increase of the magnetic energy. Meanwhile, the LED driving voltage VLED_A is generated at the output node, that is, at one end of the second resistor R1, by the electromotive force of the inductor L1 and the input voltage VIN. Further, the LED driving voltage VLED_A is charged in the capacitor C1 connected in parallel with the resistors R1 and R2. If the magnetic energy stored in the inductor L1 during the active period of the gate control signal VG is large, the electromotive force of the inductor L1 is large, and therefore the LED driving voltage VLED_A is further boosted.

Next, when the gate control signal VG is activated again, the current flows through the NMOS power transistor NMOS and the first resistor RF, and the magnetic energy is stored in the inductor L1 again. At this time, the voltage level of the LED driving voltage VLED_A is maintained by the voltage stored in the capacitor C1.

As described above, the power supply circuit 1110 increases the electromotive force of the inductor L1 to increase the LED driving voltage VLED_A when a duty ratio of the gate control signal VG increases, and decreases the electromotive force of the inductor L1 to decrease the LED driving voltage VLED_A when the duty ratio of the gate control signal VG decreases.

As illustrated in FIG. 3, the duty ratio of the gate control signal VG is changed based on a first detection voltage VDET1 corresponding to the current flowing through the NMOS power transistor NMOS and a second detection voltage VDET2 that is a sensed voltage of the LED driving voltage VLED_A.

When the LED driving voltage VLED_A is lower than a target voltage, the power supply circuit 1110 increases the duty ratio of the gate control signal VG to boost the LED driving voltage VLED_A by increasing the electromotive force of the inductor L1. On the other hand, when the LED driving voltage VLED_A is higher than the target voltage, the power supply circuit 1110 decreases the duty ratio of the gate control signal VG to lower the LED driving voltage VLED_A by decreasing the electromotive force of the inductor L1.

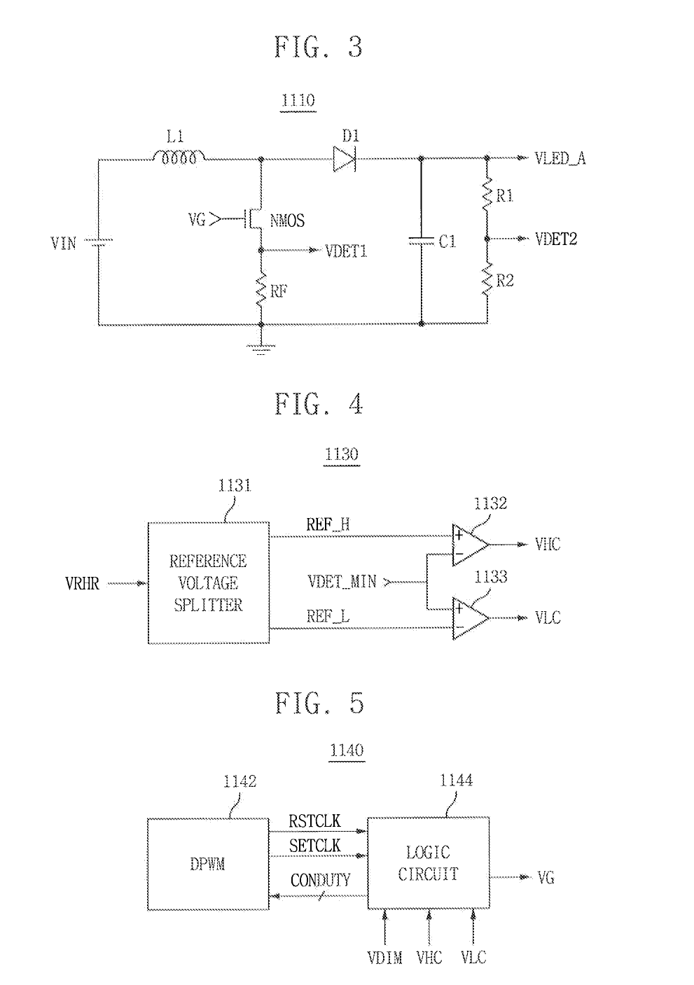

FIG. 4 is a circuit diagram illustrating a comparing circuit 1130 included in the LED driving circuit 1100 of FIG. 2, in accordance with an embodiment of the general inventive concept.

Referring to FIG. 4, the comparing circuit 1130 includes a reference voltage splitter 1131 and comparators 1132 and 1133. The reference voltage splitter 1131 generates a first reference voltage REF_H and a second reference voltage REF_L based on the headroom-control reference voltage VRHR. The comparator 1132 compares the minimum detection voltage signal VDET_MIN with the first reference voltage REF_H to generate the first comparison output signal VHC. The comparator 1133 compares the minimum detection voltage signal VDET_MIN with the second reference voltage REF_L to generate the second comparison output signal VLC.

FIG. 5 is a block diagram illustrating a digital control circuit 1140 included in the LED driving circuit 1100 of FIG. 2, in accordance with an embodiment of the general inventive concept.

Referring to FIG. 5, the digital control circuit 1140 may include a digital pulse-width-modulation (PWM) circuit 1142 and a logic circuit 1144.

The digital PWM circuit 1142 performs PWM based on a duty control code CONDUTY to generate a set clock signal SETCLK and a reset clock signal RSTCLK. The logic circuit 1144 changes the duty control code CONDUTY according to logic states of the first comparison output signal VHC and the second comparison output signal VLC, and generates the gate control signal VG based on the dimming signal VDIM, the set clock signal SETCLK and the reset clock signal RSTCLK.

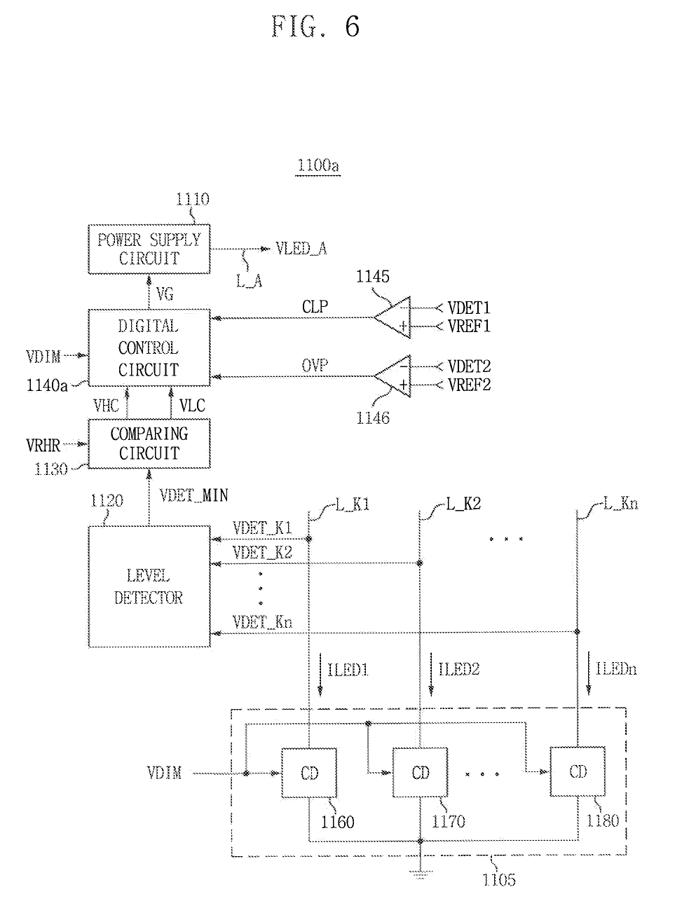

FIG. 6 is a block diagram illustrating a LED driving circuit 1100a included in the LED system 1000 of FIG. 1, in accordance with another embodiment of the general inventive concept.

Referring to FIG. 6, an LED driving circuit 1100a includes a power supply circuit 1110, a level detector 1120, a comparing circuit 1130, a digital control circuit 1140a, a current driving circuit 1105 and comparators 1145 and 1146.

The current driving circuit 1105 includes current drivers 1160, 1170 and 1180, and controls current signals ILED1, ILED2, . . . , ILEDn flowing through LED strings 1510, 1520 and 1530 in FIG. 1 in response to the dimming signal VDIM. The level detector 1120 detects a minimum detection voltage signal VDET_MIN having a minimum voltage level among voltage signals of the first terminals L_K1, L_K2, . . . , L_Kn of the respective LED strings 1510, 1520 and 1530 that correspond to the current driven through the LED strings 1510, 1520 and 1530. The comparing circuit 1130 generates a first comparison output signal VHC and a second comparison output signal VLC based on a headroom-control reference voltage VRHR and the minimum detection voltage signal VDET_MIN. The comparator 1145 compares a first detection voltage VDET1 and a first reference voltage VREF1 to generate a current-limit-protection signal CLP. The current-limit-protection signal CLP is also called an over-current protection signal. The comparator 1146 compares a second detection voltage VDET2 and a second reference voltage VREF2 to generate an over-voltage-protection signal OVP. Referring to FIG. 3, the first detection voltage VDET1 is a voltage signal corresponding to a current flowing through an NMOS power transistor NMOS, and the second detection voltage VDET2 is a sensed voltage of the LED driving voltage VLED_A. The digital control circuit 1140a adjusts a duty ratio of a gate control signal VG in a digital mode based on the first comparison output signal VHC, the second comparison output signal VLC, the over-voltage-protection signal OVP, the current-limit-protection signal CLP and the dimming signal VDIM which is a control clock signal. The power supply circuit 1110 generates the LED driving voltage VLED_A in response to the gate control signal VG.

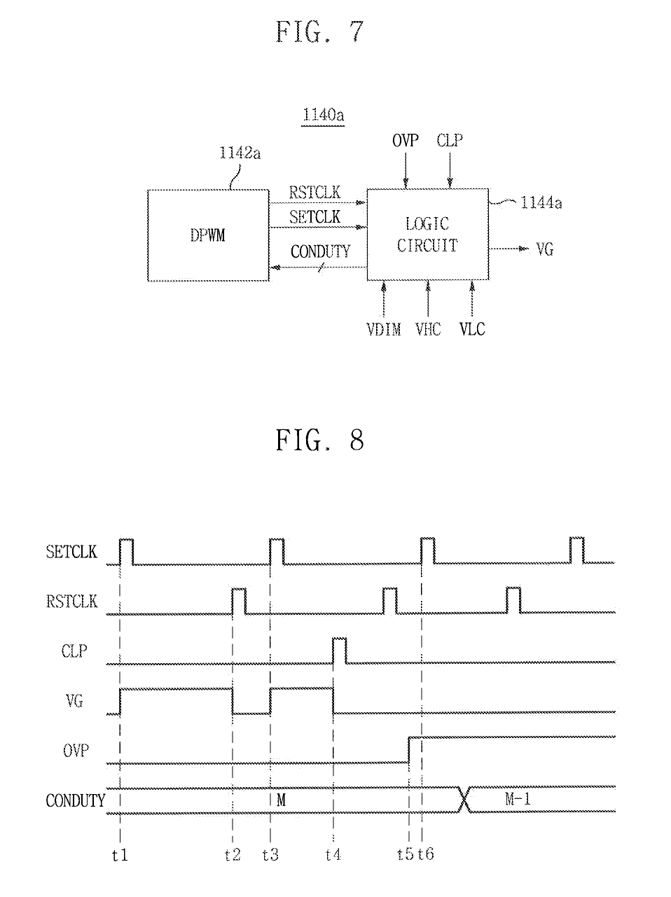

FIG. 7 is a block diagram illustrating a digital control circuit 1140a included in the LED driving circuit 1100a of FIG. 6, in accordance with an embodiment of the general inventive concept.

Referring to FIG. 7, the digital control circuit 1140a may include a digital PWM circuit 1142a and a logic circuit 1144a.

The digital PWM circuit 1142a performs PWM to generate a set clock signal SETCLK and a reset clock signal RSTCLK based on a duty control code CONDUTY. The logic circuit 1144a changes the duty control code CONDUTY according to logic states of the first comparison output signal VHC and the second comparison output signal VLC, and generates the gate control signal VG based on the dimming signal VDIM, the set clock signal SETCLK, the reset clock signal RSTCLK, the over-voltage-protection signal OVP and the current-limit-protection signal CLP.

The digital control circuit 1140a may decrease the duty control code CONDUTY by a first value and disable the gate control signal VG when the over-voltage-protection signal OVP is enabled. Further, the digital control circuit 1140a may disable the gate control signal VG when the current-limit-protection signal CLP is enabled.

FIG. 8 is a timing diagram illustrating an operation of the LED system 1000 of FIG. 1.

Referring to FIG. 8, the gate control signal VG is enabled at t1 in response to the set clock signal SETCLK, and disabled at t2 in response to the reset clock signal RSTCLK. Also, the gate control signal VG is enabled at t3 in response to the set clock signal SETCLK, and disabled at t4 in response to the current-limit-protection signal CLP. Further, as the over-voltage-protection signal OVP is enabled at t5 and maintains the enabled state, the gate control signal VG maintains the disabled state even when the set clock signal SETCLK is enabled at t6. In this condition, the digital control circuit 1140 or 1140a decreases the duty control code CONDUTY. In the example of FIG. 8, the digital control circuit 1140 or 1140a decreases the duty control code CONDUTY by 1 from M to M−1.

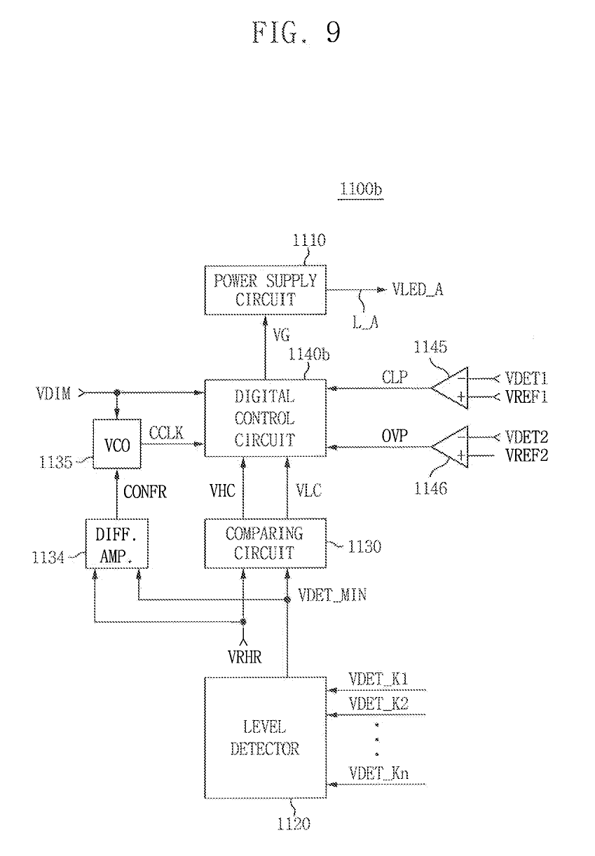

FIG. 9 is a block diagram illustrating a LED driving circuit 1100b included in the LED system 1000 of FIG. 1, in accordance with still another embodiment of the general inventive concept.

Referring to FIG. 9, an LED driving circuit 1100b includes a power supply circuit 1110, a level detector 1120, a comparing circuit 1130, a digital control circuit 1140b, a current driving circuit 1105, comparators 1145 and 1146, a differential amplifier 1134 and a voltage-controlled oscillator (VCO) 1135. In FIG. 9, the current driving circuit 1105 is omitted for convenience of explanation.

The level detector 1120 detects a minimum detection voltage signal VDET_MIN having a minimum voltage level among voltage signals of the first terminals L_K1, L_K2, . . . , L_Kn of the respective LED strings 1510, 1520 and 1530. The comparing circuit 1130 generates a first comparison output signal VHC and a second comparison output signal VLC based on a headroom-control reference voltage VRHR and the minimum detection voltage signal VDET_MIN. The comparator 1145 compares a first detection voltage VDET1 with a reference voltage VREF1 to generate a current-limit-protection signal CLP. The comparator 1146 compares a second detection voltage VDET2 with a reference voltage VREF2 to generate an over-voltage-protection signal OVP. Referring to FIG. 3, the first detection voltage VDET1 is a voltage signal corresponding to a current flowing through the NMOS power transistor NMOS, and the second detection voltage VDET2 is a sensed voltage of the LED driving voltage VLED_A. The differential amplifier 1134 amplifies a difference between the headroom control reference voltage VRHR and the minimum detection voltage signal VDET_MIN to generate a frequency control signal CONFR. The VCO 1135 generates a control clock signal CCLK based on the dimming signal VDIM and the frequency control signal CONFR. The digital control circuit 1140b adjusts a duty ratio of the gate control signal VG in a digital mode based on the first comparison output signal VHC, the second comparison output signal VLC, the over-voltage-protection signal OVP, the current-limit-protection signal CLP, the dimming signal VDIM and the control clock signal CCLK. The power supply circuit 1110 generates an LED driving voltage VLED_A in response to the gate control signal VG.

The frequency of the control clock signal CCLK may decrease when the minimum detection voltage signal VDET_MIN approaches a target value, and increase when the minimum detection voltage signal VDET_MIN deviates from the target value.

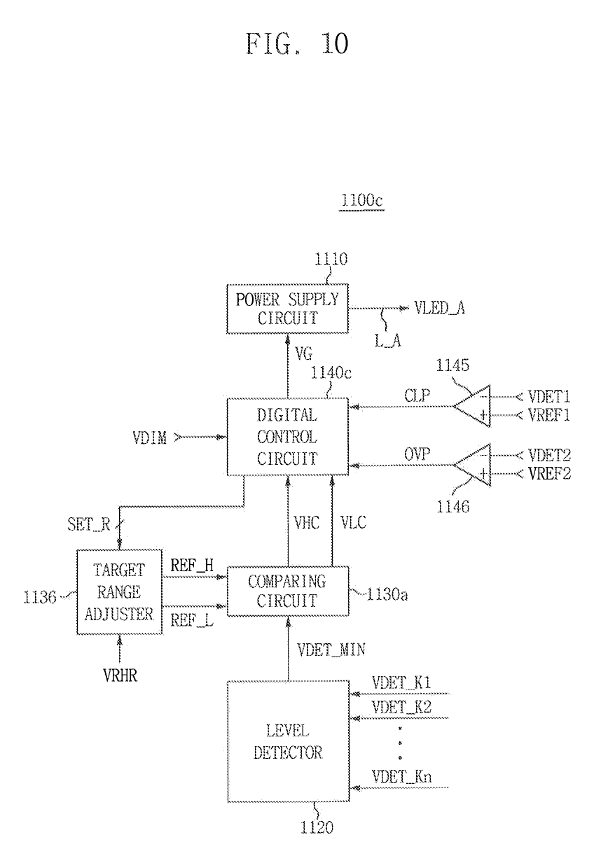

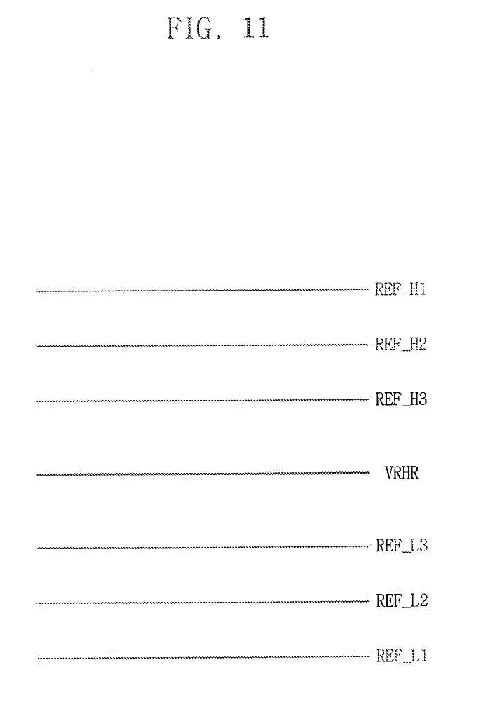

FIG. 10 is a block diagram illustrating a LED driving circuit 1100c included in the LED system 1000 of FIG. 1, in accordance with yet another embodiment of the general inventive concept.

Referring to FIG. 10, an LED driving circuit 1100c includes a power supply circuit 1110, a level detector 1120, a comparing circuit 1130a, a target-range adjusting circuit 1136, a digital control circuit 1140c, a current driving circuit 1105 and comparators 1145 and 1146. In FIG. 10, the current driving circuit 1105 is not illustrated for convenience of explanation.

The level detector 1120 detects a minimum detection voltage signal VDET_MIN having a minimum voltage level among voltage signals of the first terminals L_K1, L_K2, . . . , L_Kn of the respective LED strings 1510, 1520 and 1530. The target-range adjusting circuit 1136 generates a first reference voltage REF_H and a second reference voltage REF_L based on the headroom-control reference voltage VRHR, and adjusts voltage levels of the first reference voltage REF_H and the second reference voltage REF_L in response to a reference-voltage setting signal SET_R. The comparing circuit 1130a generates a first comparison output signal VHC and a second comparison output signal VLC based on the first reference voltage REF_H, the second reference voltage REF_L and the minimum detection voltage signal VDET_MIN. The comparator 1145 compares a first detection voltage VDET1 with a first reference voltage VREF1 to generate a current-limit-protection signal CLP. The comparator 1146 compares a second detection voltage VDET2 with a second reference voltage VREF2 to generate an over-voltage-protection signal OVP. Referring to FIG. 3, the first detection voltage VDET1 is a voltage signal corresponding to a current flowing through the NMOS power transistor NMOS, and the second detection voltage VDET2 is a sensed voltage of the LED driving voltage VLED_A. The digital control circuit 1140c adjusts a duty ratio of the gate control signal VG in a digital mode based on the first comparison output signal VHC, the second comparison output signal VLC, the over-voltage-protection signal OVP, the current-limit-protection signal CLP, and the dimming signal VDIM which is a control clock signal. The power supply circuit 1110 generates an LED driving voltage VLED_A in response to the gate control signal VG.

FIG. 11 is a diagram illustrating reference voltages used in the comparing circuit 1130a included in the LED driving circuit 1100c of FIG. 10, in accordance with an embodiment of the general inventive concept.

As illustrated in FIG. 11, the target-range adjusting circuit 1136 adjusts voltage levels of the first reference voltage REF_H and the second reference voltage REF_L in response to a reference-voltage setting signal SET_R. In the example of FIG. 11, the first reference voltage REF_H may have three voltage levels REF_H1, REF_H2 and REF_H3 higher than the voltage level of the headroom-control reference voltage VRHR, and the second reference voltage REF_L may have three voltage levels REF_L1, REF_L2 and REF_L3 lower than the voltage level of the headroom-control reference voltage VRHR.

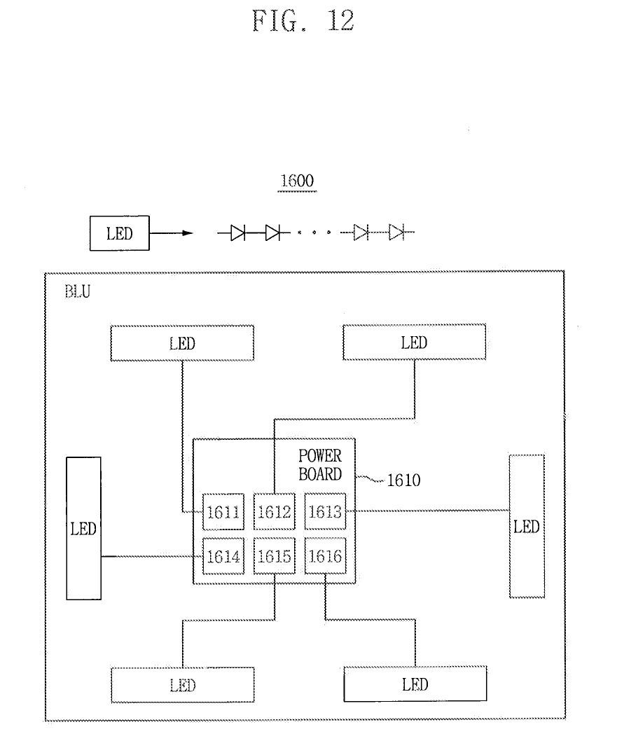

FIG. 12 is a block diagram illustrating an example of a back-light system 1600 including an LED driving circuit in accordance with embodiments of the general inventive concept.

Referring to FIG. 12, the back-light system 1600 includes a back-light unit BLU, a power board 1610 included in the back-light unit BLU and LED arrays LED. Each of the LED arrays LED may include at least one LED string. The LED string may include at least one LED. The power board 1610 includes LED driving circuits 1611 to 1616 having a similar circuit structure to the LED driving circuits 1100, 1100a, 1100b and 1100c illustrated in FIGS. 1, 2, 6, 9 and 10. Each of the LED driving circuits 1611 to 1616 generates a gate driving signal in a digital mode, thus having a simple structure and occupying a small area in a semiconductor integrated circuit.

Accordingly, the back-light system 1600 including the LED driving circuits 1611 to 1616 has a simple circuit structure and operates at a high speed.

The back-light system 1600 illustrated in FIG. 12 may be applied to display devices including large display panels such as edge-type LED television sets.

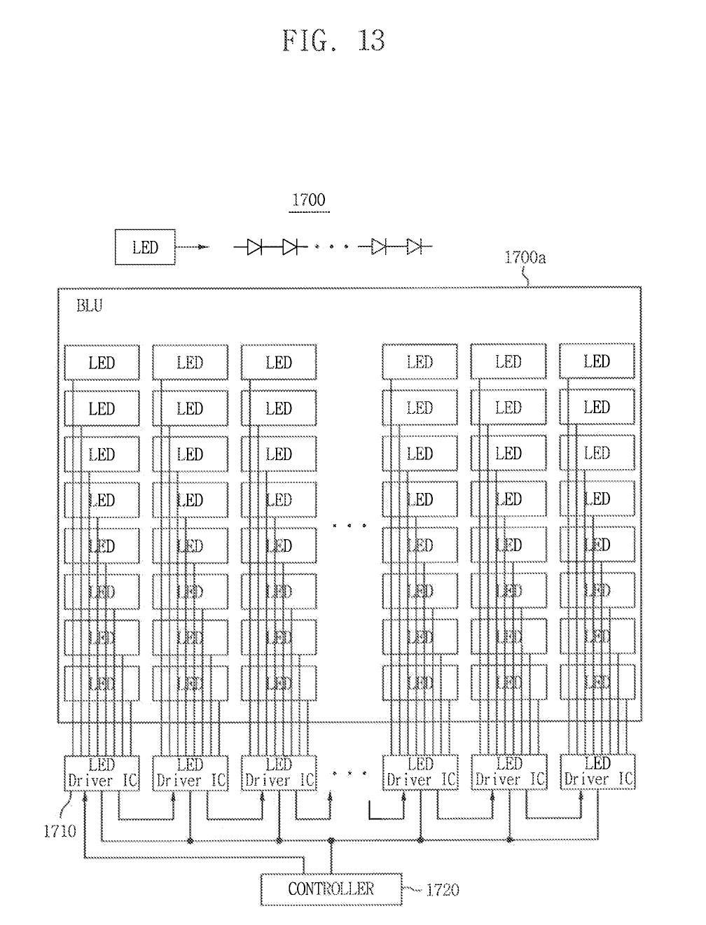

FIG. 13 is a block diagram illustrating another example of a back-light system including an LED driving circuit in accordance with embodiments of the general inventive concept.

Referring to FIG. 13, a back-light system 1700 includes a back-light unit BLU including LED arrays LED, a controller 1720, and LED drivers 1710 driving the LED arrays LED under the control of the controller 1720. Each of the LED arrays LED may include at least one LED string. The LED string may include at least one LED.

Each of the LED drivers 1710 has a similar circuit structure to the LED driving circuits 1100, 1100a, 1100b or 1100c illustrated in FIGS. 1, 2, 6, 9 and 10. Each of the LED drivers 1710 generates a gate driving signal in a digital mode, thus having a simple structure and occupying a small area in a semiconductor integrated circuit.

Accordingly, the back-light system 1700 including the LED drivers 1710 has a simple circuit structure and operates at a high speed.

The back-light system 1700 illustrated in FIG. 13 may be applied to display devices including large display panels such as direct-type LED television sets.

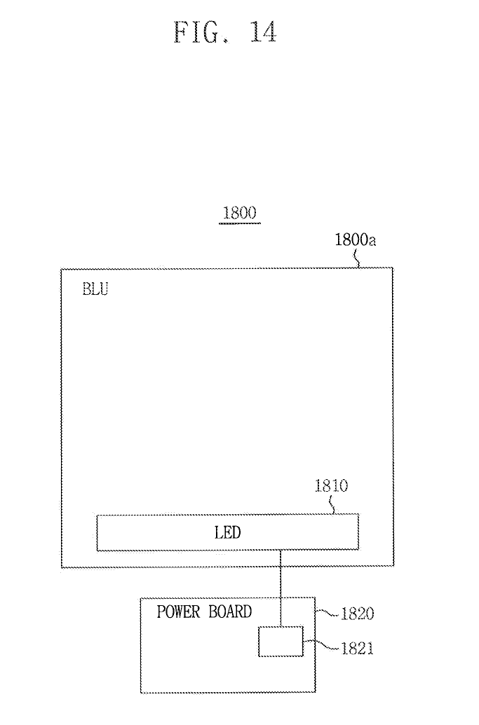

FIG. 14 is a block diagram illustrating still another example of a back-light system including an LED driving circuit in accordance with embodiments of the general inventive concept.

Referring to FIG. 14, a back-light system 1800 includes a back-light unit (BLU) 1800a including LED arrays LED, a power board 1820 that is outside of the BLU 1800a. Each of the LED arrays (LED) 1810 may include at least one LED string. The LED string may include at least one LED. The power board 1820 includes an LED driving circuit 1821 having a similar circuit structure as the LED driving circuits 1100, 1100a, 1100b or 1100c illustrated in FIGS. 1, 2, 6, 9 and 10. Each of the LED driving circuits 1821 generates a gate driving signal in a digital mode, thus having a simple circuit structure and occupying a small area in a semiconductor integrated circuit.

Accordingly, the back-light system 1800 including the LED driving circuits 1821 has a simple circuit structure and operates at a high speed.

The back-light system 1800 illustrated in FIG. 14 may be applied to display devices including small display panels such as a mobile phone, a personal digital assistant (PDA) and a portable multimedia player (PMP).

In the above, the back-light driving circuit mainly used in a liquid-crystal-display panel (LCD) is described, but the example embodiments may be applied to general display devices such as a plasma display panel (PDP), an organic light emitting diode (OLED) and an LED for lamp.

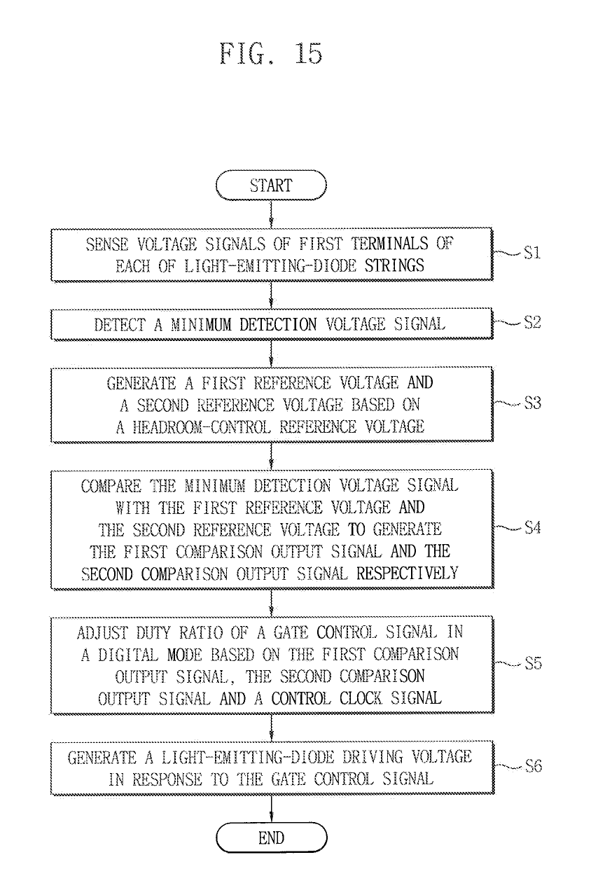

FIG. 15 is a flowchart illustrating a method of driving an LED, in accordance with an embodiment of the general inventive concept.

Referring to FIG. 15, the method of driving an LED may include the following operations of: sensing voltage signals of first terminals of respective LED strings (operation S1); detecting a minimum detection voltage signal having a minimum voltage level among the voltage signals of the first terminals of the respective LED strings (operation S2); generating a first reference voltage and a second reference voltage having a lower voltage level than the first reference voltage based on a headroom-control reference voltage (operation S3); comparing the minimum detection voltage signal with the first reference voltage and the second reference voltage to generate a first comparison output signal and a second comparison output signal respectively (operation S4); adjusting a duty ratio of a gate control signal in a digital mode based on the first comparison output signal, the second comparison output signal and a control clock signal (operation S5); and generating an LED driving voltage in response to the gate control signal (operation S6).

The method of driving an LED in accordance with an embodiment of the general inventive concept may further include providing the LED driving voltage to second terminals of the respective LED strings.

The headroom-control reference voltage may include information about an LED current.

The first comparison output signal may be enabled when a magnitude of the minimum detection voltage signal is larger than a magnitude of the first reference voltage, and the second comparison output signal may be enabled when the magnitude of the minimum detection voltage signal is smaller than a magnitude of the second reference voltage.

The first comparison output signal may be disabled when a magnitude of the minimum detection voltage signal is smaller than the magnitude of the first reference voltage, and the second comparison output signal may be disabled when the magnitude of the minimum detection voltage signal is larger than the magnitude of the second reference voltage.

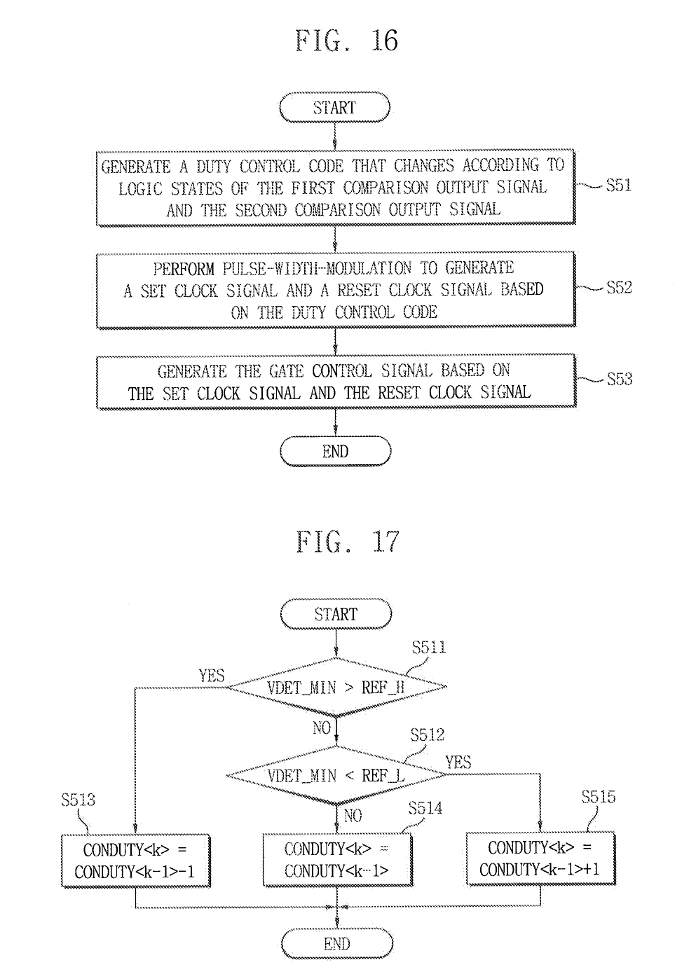

FIG. 16 is a flowchart illustrating a method of adjusting the duty ratio of a gate control signal included in FIG. 15, in accordance with an embodiment of the general inventive concept.

Referring to FIG. 16, the method of adjusting the duty ratio of a gate control signal includes the following operations of: generating a duty control code that changes according to logic states of the first comparison output signal and the second comparison output signal (operation S51); performing PWM based on the duty control code to generate a set clock signal and a reset clock signal (operation S52); and generating the gate control signal based on the set clock signal and the reset clock signal (operation S53).

FIG. 17 is a flowchart illustrating a method of generating a duty control code included in FIG. 16, in accordance with an embodiment of the general inventive concept.

Referring to FIG. 17, the method of generating a duty control code includes the following operations of: determining whether the minimum detection voltage signal has a higher voltage level than the first reference voltage (operation S511); decreasing the duty control code by a first value when the minimum detection voltage signal has a higher voltage level than the first reference voltage (operation S513); determining whether the minimum detection voltage signal has a lower voltage level than the second reference voltage when the minimum detection voltage signal has a voltage level equal to or lower than a voltage level of the second reference voltage (operation S512); increasing the duty control code by the first value when the minimum detection voltage signal has a lower voltage level than the second reference voltage (operation S515); and maintaining the duty control code in a prior value when the minimum detection voltage signal has a voltage level equal to or higher than the voltage level of the second reference voltage (operation S514).

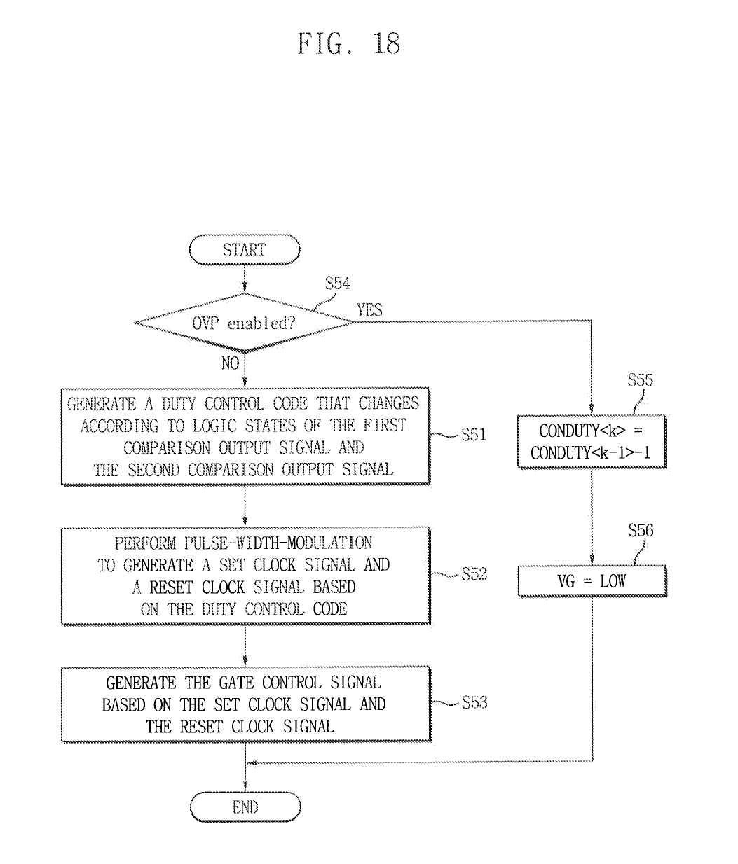

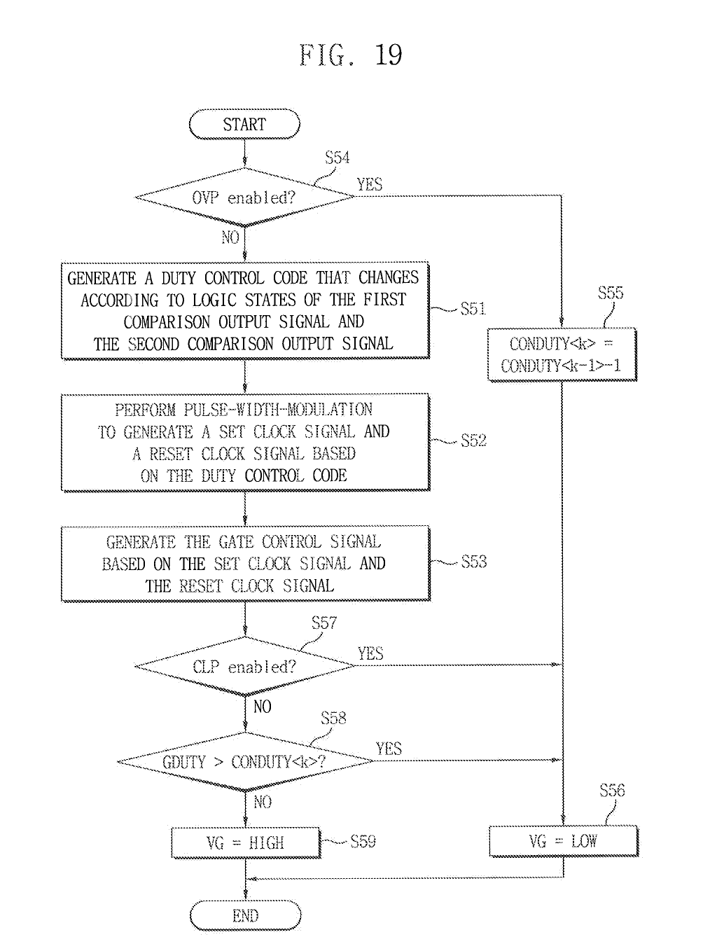

FIG. 18 is a flowchart illustrating a method of adjusting the duty ratio of a gate control signal included in FIG. 15, in accordance with another embodiment of the general inventive concept.

Referring to FIG. 18, the method of adjusting the duty ratio of a gate control signal includes the following operations of: determining whether an over-voltage-protection signal OVP is enabled (operation S54); decreasing the duty control code CONDUTY by a first value to disable the gate control signal VG when the over-voltage-protection signal OVP is enabled (operations S55 and S56); generating a duty control code CONDUTY that changes according to logic states of the first comparison output signal and the second comparison output signal when the over-voltage-protection signal OVP is disabled (operation S51); performing PWM based on the duty control code CONDUTY to generate a set clock signal SETCLK and a reset clock signal RSTCLK (operation S52); and generating the gate control signal VG based on the set clock signal SETCLK and the reset clock signal RSTCLK (operation S53).

FIG. 19 is a flowchart illustrating a method of adjusting the duty ratio of a gate control signal included in FIG. 15, in accordance with still another embodiment of the general inventive concept.

Referring to FIG. 19, the method of adjusting the duty ratio of a gate control signal includes the following operations of: determining whether an over-voltage-protection signal OVP is enabled (operation S54); decreasing the duty control code CONDUTY by a first value to disable the gate control signal when the over-voltage-protection signal OVP is enabled (operations S55 and S56); generating a duty control code CONDUTY according to logic states of the first comparison output signal and the second comparison output signal when the over-voltage-protection signal OVP is disabled (operation S51); performing PWM based on the duty control code CONDUTY to generate a set clock signal SETCLK and a reset clock signal RSTCLK (operation S52); generating the gate control signal VG based on the set clock signal SETCLK and the reset clock signal RSTCLK (operation S53); determining whether a current-limit-protection signal CLP is enabled (operation S57); disabling the gate control signal VG when the current-limit-protection signal CLP is enabled (operation S56); determining whether a duty ratio of the gate control signal VG is larger than a duty ratio of the duty control code CONDUTY when the current-limit-protection signal CLP is disabled (operation S58); disabling the gate control signal VG when the duty ratio of the gate control signal VG is larger than the duty ratio of the duty control code CONDUTY (operation S56); and enabling the gate control signal VG when the duty ratio of the gate control signal VG is equal to or smaller than the duty ratio of the duty control code CONDUTY (operation S59).

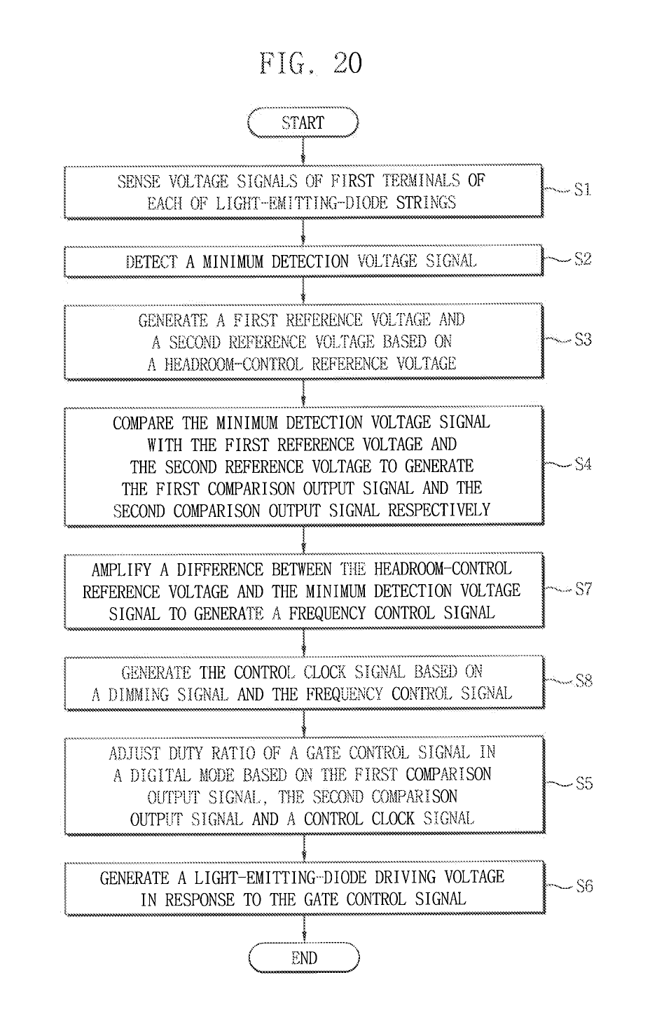

FIG. 20 is a flowchart illustrating a method of driving an LED, in accordance with another embodiment of the general inventive concept.

Referring to FIG. 20, the method of driving an LED includes the following operations of: sensing voltage signals of first terminals of respective LED strings (operation S1); detecting a minimum detection voltage signal having a minimum voltage level among the voltage signals of the first terminals of the respective LED strings (operation S2); generating a first reference voltage and a second reference voltage having a lower voltage level than the first reference voltage based on a headroom-control reference voltage (operation S3); comparing the minimum detection voltage signal with the first reference voltage and the second reference voltage to generate a first comparison output signal and a second comparison output signal respectively (operation S4); amplifying a difference between the headroom-control reference voltage and the minimum detection voltage signal to generate a frequency control signal (operation S7); generating a control clock signal based on a dimming signal and the frequency control signal (operation S8); adjusting a duty ratio of a gate control signal in a digital mode based on the first comparison output signal, the second comparison output signal and the control clock signal (operation S5); and generating an LED driving voltage in response to the gate control signal (operation S6).

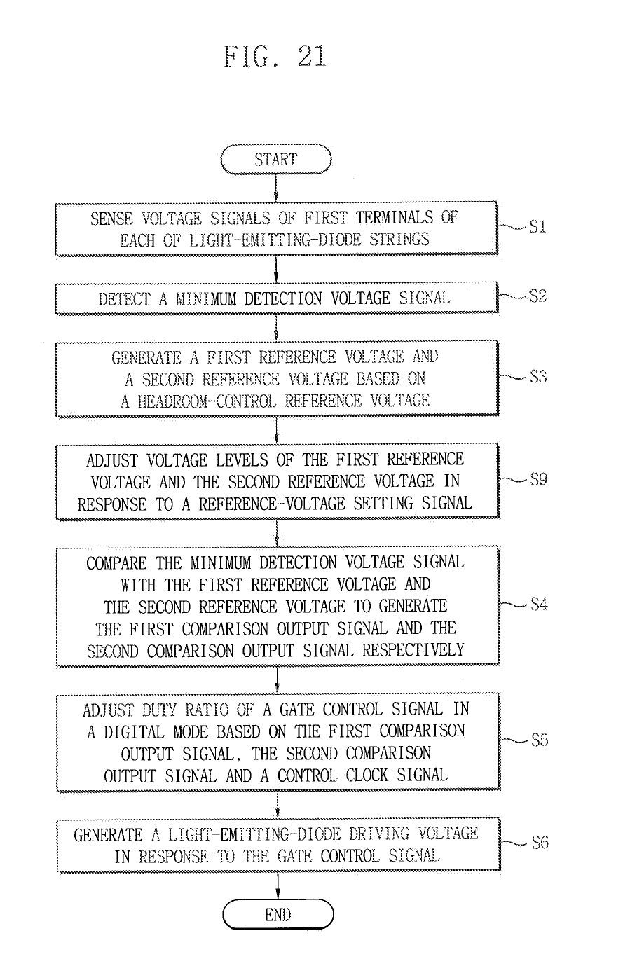

FIG. 21 is a flowchart illustrating a method of driving an LED, in accordance with still another embodiment of the general inventive concept.

Referring to FIG. 21, the method of driving an LED includes the following operations of: sensing voltage signals of first terminals of respective LED strings (operation S1); detecting a minimum detection voltage signal having a minimum voltage level among the voltage signals of the first terminals of the respective LED strings (operation S2); generating a first reference voltage and a second reference voltage having a lower voltage level than the first reference voltage based on a headroom-control reference voltage (operation S3); adjusting voltage levels of the first reference voltage and the second reference voltage in response to a reference-voltage setting signal (operation S9); comparing the minimum detection voltage signal with the first reference voltage and the second reference voltage to generate the first comparison output signal and the second comparison output signal respectively (operation S4); adjusting a duty ratio of a gate control signal in a digital mode based on the first comparison output signal, the second comparison output signal and a control clock signal (operation S5); and generating an LED driving voltage in response to the gate control signal (operation S6).

As described above, a circuit and method to drive an LED in accordance with embodiments of the general inventive concept have a simple circuit structure and require a small area in a semiconductor integrated circuit because a gate driving signal is generated in a digital mode.

Embodiments of the general inventive concept may be applied to display devices and lighting devices, particularly to a backlight unit of the display devices.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this general invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A light-emitting-diode (LED) driving circuit, comprising:
a current driving circuit configured to control current signals flowing through LED strings;
a level detector configured to detect a minimum detection voltage signal having a minimum voltage level among voltage signals of first terminals of the respective LED strings;
a comparing circuit configured to generate a first comparison output signal and a second comparison output signal based on a headroom-control reference voltage and the minimum detection voltage signal;
a digital control circuit configured to adjust a duty ratio of a gate control signal in a digital mode based on the first comparison output signal, the second comparison output signal and a control clock signal; and
a power supply circuit configured to generate an LED driving voltage in response to the gate control signal.

2. The LED driving circuit of claim 1, wherein the headroom-control reference voltage includes information about an LED current.

3. The LED driving circuit of claim 1, wherein the comparing circuit generates a first reference voltage and a second reference voltage having a lower voltage level than the first reference voltage based on the headroom-control reference voltage, and compares the minimum detection voltage signal with the first reference voltage and the second reference voltage to generate the first comparison output signal and the second comparison output signal respectively.

4. The LED driving circuit of claim 3, wherein the first comparison output signal is enabled when a magnitude of the minimum detection voltage signal is larger than a magnitude of the first reference voltage, and
the second comparison output signal is enabled when the magnitude of the minimum detection voltage signal is smaller than a magnitude of the second reference voltage.

5. The LED driving circuit of claim 3, wherein the first comparison output signal is disabled when a magnitude of the minimum detection voltage signal is smaller than a magnitude of the first reference voltage, and
the second comparison output signal is disabled when the magnitude of the minimum detection voltage signal is larger than a magnitude of the second reference voltage.

6. The LED driving circuit of claim 1, wherein the digital control circuit includes:
a digital pulse-width-modulation (PWM) circuit configured to perform PWM based on a duty control code to generate a set clock signal and a reset clock signal; and
a logic circuit configured to change the duty control code according to logic states of the first comparison output signal and the second comparison output signal, and generate the gate control signal based on the set clock signal and the reset clock signal.

7. The LED driving circuit of claim 6, wherein the digital control circuit decreases the duty control code by a first value and disables the gate control signal when an over-voltage-protection signal is enabled.

8. The LED driving circuit of claim 6, wherein the digital control circuit disables the gate control signal when a current-limit-protection signal is enabled.

9. The LED driving circuit of claim 1, further comprising:
a differential amplifier configured to amplify a difference between the headroom-control reference voltage and the minimum detection voltage signal to generate a frequency control signal; and
a voltage-controlled oscillator (VCO) configured to generate the control clock signal based on a dimming signal and the frequency control signal.

10. The LED driving circuit of claim 9, wherein a frequency of the control clock signal decreases when the minimum detection voltage signal approaches a target value, and increases when the minimum detection voltage signal deviates from the target value.

11. The LED driving circuit of claim 1, further comprising:
a target-range adjusting circuit configured to generate a first reference voltage and a second reference voltage based on the headroom-control reference voltage, and adjust voltage levels of the first reference voltage and the second reference voltage in response to a reference-voltage setting signal.

12. A display device, comprising:
a display panel;
a back-light driving circuit configured to detect a minimum detection voltage signal having a minimum voltage level among terminal voltage signals of respective light-emitting-diode (LED) strings, generate comparison output signals based on a headroom-control reference voltage and the minimum detection voltage signal, adjust a duty ratio of a gate control signal in a digital mode based on the comparison output signals and a control clock signal, and generate an LED driving voltage in response to the gate control signal; and
a back-light unit including the LED strings, and configured to operate in response to the LED driving voltage and provide light to the display panel.

13. The display device of claim 12, wherein the back-light driving circuit includes:
a current driving circuit configured to control current signals flowing through the LED strings;
a level detector configured to detect the minimum detection voltage signal;
a comparing circuit configured to generate the first comparison output signal and the second comparison output signal based on the headroom-control reference voltage and the minimum detection voltage signal;
a digital control circuit configured to adjust the duty ratio of the gate control signal in the digital mode; and
a power supply circuit configured to generate the LED driving voltage in response to the gate control signal.

14. The display device of claim 13, wherein the comparing circuit generates a first reference voltage and a second reference voltage having a lower voltage level than the first reference voltage based on the headroom-control reference voltage, and compares the minimum detection voltage signal with the first reference voltage and the second reference voltage to generate the first comparison output signal and the second comparison output signal respectively.

15. The display device of claim 14, wherein the first comparison output signal is enabled when a magnitude of the minimum detection voltage signal is larger than a magnitude of the first reference voltage, and
the second comparison output signal is enabled when the magnitude of the minimum detection voltage signal is smaller than a magnitude of the second reference voltage.

16. A light-emitting diode (LED) driving circuit including a power supply circuit to supply a driving voltage to an LED array, the driving circuit comprising:
a level detector to detect a minimum voltage output from the LED array;
a comparing circuit to output a plurality of comparison signals based on the detected minimum voltage and a headroom-control reference voltage (VRHR); and
a digital control circuit to output a gate control signal to a gate of a NMOS power transistor of the power circuit such that a duty ratio of the gate control signal is changed based on a detection voltage of the NMOS power transistor and the driving voltage of the LED array.

17. The LED driving circuit of claim 16, wherein the detection voltage of the NMOS power transistor corresponds to the current flowing through the NMOS power transistor.

18. The LED driving circuit of claim 16, wherein the digital control circuit includes a digital pulse width modulation circuit and a logic circuit.

19. The LED driving circuit of claim 16, wherein the digital control circuit adjusts the duty ratio of the gate control signal based on an over-voltage protection signal, a current-limit protection signal and a dimming signal.

20. The LED driving circuit of claim 16, wherein the comparing circuit generates a first reference voltage and a second reference voltage having a lower voltage level the first reference level based on the VRHR and compares the minimum voltage output from the LED array with the first reference voltage and the second reference voltage to generate the plurality of comparison signals output by the comparing circuit.
